(19) United States
(12) Patent Application Publication
(10) Pub. No.: US 2026/0213908 A1
(43) Pub. Date: Jul. 23, 2026

(54) PNT Assisted Spectrum Sharing (PASS) for Real-Time Continuous, Dynamic Optimization of Access Point Interference

(71) Applicant: Virginia Tech Applied Research Corporation, Arlington, VA (US)

(72) Inventors: Glenn Michael Smith, Arlington, VA (US); Michael Edward DiFrancisco, Arlington, VA (US); Ankur Ashwin Mistry, Arlington, VA (US); Michael Stephen Miller, Arlington, VA (US)

(21) Appl. No.: 19/032,369

(22) Filed: Jan. 20, 2025

(51) Int. Cl. H04L 5/00; H04B 17/309; H04W 16/14; H04W 24/02; H04W 72/541

(52) U.S. Cl. CPC H04L 5/0073; H04B 17/347; H04W 16/14; H04W 72/541; H04W 24/02

(57) ABSTRACT

Providing a system and method to perform and utilize real-time measurements at each Access Point (AP) determining hemispheric directional propagation characteristics. The system gathers these characteristics to determine the individual and aggregated AP Power Flux Density (PFD) at incumbent asset receivers with established sensitivity thresholds. The system also gathers incumbent asset receiver information to calculate each incumbent receiver threshold for interference protection. The system then compares the aggregated AP PFD at each incumbent asset receiver requiring protection and uses algorithms to determine how best to optimize the network AP emissions to reduce the aggregated AP PFD below each incumbent receiver's threshold. The innovation then creates and transmits to one or more users predictions and mitigation recommendations in real-time for the continuous, dynamic optimization of interference for each AP to optimize the network aggregated emissions and protect the incumbent receivers. These processes are repeated continuously.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The field of this invention relates to a system performing real-time measurements at a number of Access Points (AP) to determine directional propagation characteristics and create each Access Point hemispherical propagation characteristics. The system will report predictions and mitigation recommendations in real-time for the continuous, dynamic optimization of interference for each Access Point.

### FIGURES

FIG. 1—this figure presents a view of the operational flow for the PASS incumbent management portal information generation, processing, and presentation consistent with the present disclosure.

FIG. 2—this figure presents a structural representation of the PASS incumbent analysis portal and Network Integration consistent with the present disclosure.

FIG. 3—this figure presents a view of the operational flow for the continuous calculation of AP Downlink emissions to be incrementally optimized to provide incumbent receiver protection consistent with the present disclosure.

### PASS DATA FLOW AND ALGORITHM ELEMENT DEFINITIONS

The following definitions apply across this document:
Access Point (AP)—A 4G/5G/6G/XG wireless network sector or cell device or system of devices.
APᵢ—the i^{th} AP in a count from i=1 to i=N across N APs in a designated wireless network.
EIRP_{APi}—Equivalent Isotropic Radiated Power for the i^{th} AP from i=1 to i=N across N APs in a designated wireless network (in dBm) for a specific 3GPP band.
BEL—Building Exit Loss (in dBm) for a specific 3GPP band.
BW—Bandwidth in units based on Hz.
Clutter—A RF spectral environment comprised of various absorbing, reflecting, and diffracting entities to be described by Excess Pathloss (in dB) for a specific 3GPP band.
G_{Rxi}—Receive antenna gain (could be a vector) for Incumbent Receiver Rx i (in dB) for a specific 3GPP band.
G_{t(APi)}—Transmit antenna gain vector for APᵢ (in dB) for a specific 3GPP band.
(I/N)_{Rx-i}—Incumbent Receiver Sensitivity Threshold—This is the Interference-to-Noise ratio (in dB) for the i^{th} Incumbent Receiver device requiring protection in a count from i=1 to i=N. This value when combined with the incumbent receiver device sensitivity level establishes the allowed aggregated interference level for that incumbent receiver. The combined power of the incumbent receiver sensitivity level and the aggregated interference level defines the permissible desensitization level of that receiver device from its noise only defined sensitivity performance level.
kTB—The thermal noise level (in dBm) across the incumbent receiver BW B. For our purposes, this is assumed to be the Incumbent Receiver Sensitivity where the Signal-to-Noise Ratio (SNR) is 0 dB for each incumbent receiver device.
L_{cable(APi)}—Coaxial cable loss (in dB) between a transmitter device and its antenna.
L_{epl(APi)}-Excess Path loss vector for each APᵢ (in dB) at a known spectral location.
PFD—Power Flux Density—PFD is a measure of the strength of radiation in the far field and is characterized by the amount of energy that flows through an area per unit of time. It is measured in watts per square meter (W/m²) and can be represented as dBm over that same area.
P_{t(APi)}—Transmit Power of APᵢ (in dBm) for a specific 3GPP band.
Rx₍ᵢ₎—The i^{th} Incumbent Receiver device.

The PNT Assisted Spectrum Sharing System (PASS) system provides a novel application of extremely low power measurement technologies to address current and future dynamic spectrum sharing needs. The novel system leverages data derived from the extremely accurate measurement of time determinant RF signals across a wide dynamic range down to below −175 dBm. These measurements describe an accurate real-time hemispherical, directional excess pathloss environment for every 4G/5G/XG Access Point (AP). Multitudes of the 4G/5G/XG AP directional excess pathloss representations are used with associated 4G/5G/XG AP directional EIRP information to accurately determine an aggregate interference incident signal strength at an incumbent asset receiver device. In a non-limiting example, the incumbent asset receiver device could be a national security asset.

The 4G/5G/XG AP directional excess pathloss information is used to convey to the interference contributing 4G/5G/XG APs the limits on the power each AP can emit in specific directions to mitigate interference to any target incumbent asset receiver device(s). In non-limiting examples, possible actions to mitigate interference to an incumbent asset receiver device may include 1) AP Down Link (DL) resource PRB control to avoid certain bandwidth portions, 2) AP DL antenna beam pointing control (if the incumbent asset receiver device is capable of this action), 3) AP DL antenna null pointing control (if the incumbent asset receiver device is capable of this action), 4) AP load balancing through the movement of emissions from interfering spectrum band to another band at the same AP location, and/or 5) AP DL emissions temporarily halted.

The PASS Dynamic Spectrum Sharing (DSS) system and method may leverage live, continuous measurements of the propagation space surrounding each 4G/5G/XG AP where measurements are performed. Most DSS systems envisioned and/or in use to date utilize propagation modeling rather than using live, continuous measurements of the propagation space to determine the AP Excess Pathloss.

The PASS DSS provides live, continuous measurement of the propagation space surrounding multiple 4G/5G/XG APs continuously from many wireless network base stations in real time. This measurement capability permits the PASS system to process this data and determine what wireless network assets, where each wireless network assets is composed of one or more devices, need to be optimized to minimize interference to operating incumbent assets in seconds rather than hours. The system and method provide a more proactive method for implementing dynamic spectrum sharing than systems that are based on modeling as opposed to live, real-time data measurements.

In a non-limiting example, the excess pathloss measurement capability, applicable for APs indoor and within dense urban/suburban clutter environments, provides an accurate, continuous hemispherical excess pathloss representation. Indoor DAS deployments require the excess pathloss measurement capability at key locations within the indoor environment covering one or more DAS sectors to provide the Building Exit Loss (BEL) for the DAS sectors included in the indoor DAS deployment being measured. The RAN edge compute architecture is active to utilize the AP excess loss environment data to process network-wide AP directional EIRPs. The compute architecture then optimizes wireless network devices to mitigate interference to incumbent asset devices and maintain optimal performance. In a non-limiting example, the incumbent asset may be a national security asset.

In an embodiment, the live, continuous measurements of the propagation space about each 4G/5G/XG AP is directional. The real-time directional excess propagation loss measurements may be used to determine overall propagation loss. These real-time directional excess propagation loss measurements may be subsequently aggregated appropriately to calculate and establish interference toward incumbent assets. The measurements may be used to enable/implement interference mitigation methods available to wireless network operators. The mitigation methods may include, but are not limited to, 1) AP DL resource PRB control to avoid certain bandwidth portions, 2) AP DL antenna beam pointing control when this capability is present, 3) AP DL antenna null pointing control when this capability is present, 4) AP load balancing by moving emissions from interfering spectrum bands to different bands within the same AP location, and 5) AP DL emissions are temporarily halted.

### PASS Data Flow and Algorithm Inputs, Calculations, and Outputs Descriptions

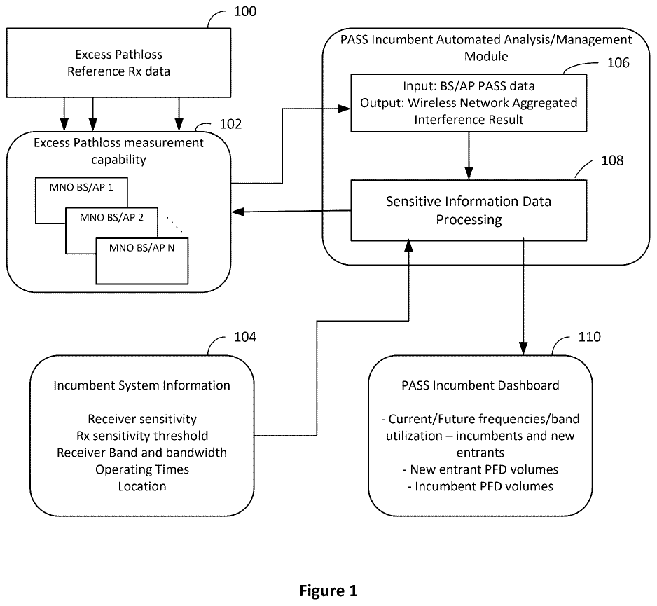

The descriptions of the PASS algorithms align with the Data Flow presented in FIG. 1. The data flow description presents the flow sequence with the algorithm inputs, calculations, and outputs for each data flow step presented in the figure.

Excess path loss measurements at each AP define excess path loss hemispherical “volume”, which provides a description of the excess path loss in every direction from the location of the AP.

These measured data sets are created continuously and each AP's hemispherical excess pathloss environment/characteristic is updated continuously. This captures the effects of RF fades and real time clutter environment changes continuously and directionally.

The measured data set is a set of vectors which define a hemispherical excess pathloss environment/characteristic defined by that AP's associated local “clutter” which includes the effects of trees, buildings, doors (opening and closing), vehicles (stationary and in motion), road features nearby, Building Exit Loss (BEL), etc. Each excess path loss vector is represented by L_{epl(APi)} (dB) for AP i.

The L_{epl(APi)} data sets are delivered from each AP to the Sensitive Information Data Processing (SIDP) data block within the PASS Incumbent Automated Analysis/Management portal active on one or more data servers or cloud connected data processors.

The APs may provide data supporting the EIRP “volume” determination information for each AP to the incumbent portal on a periodic basis, where the period is a pre-set time period. The pre-set time period may be managed, changed, and/or updated through the PASS Incumbent Automated Analysis/Management portal. Each AP also has a directional EIRP data set, inclusive of meta data, which contains location and timestamp data delivered continuously as well. The data provided from each AP may include, as a minimum but not limited to, the 3GPP channel data, current time, the AP location in GPS coordinates, and the AP directional EIRP for each 3GPP channel active within the AP.

The EIRP is the product of the AP transmit power (Pt) for the specific 3GPP channel, and the associated cell transmit antenna gain (Gₜ) for every direction. The SP antenna gain has an associated three-dimensional gain profile (antenna pattern data), thereby establishing the “Directional ETRP” for that AP at the 3GPP channel. This can also include the effects of RF cable loss (L_{cable}) between the transmitter and the antenna.

The combination of the AP EIRP data set and the AP meta data set establishes each AP's EIRP “volume” (which is also hemispherical in nature).

In a non-limiting example, the EIRP volume may be calculated as:

$${EIRP}_{A P i} ( dBm ) = {P}_{t ( A P i )} ( dB ) + {G}_{t ( A P i )} ( dB ) - {L}_{c a b l e ( A P i )} ( dB )$$

The calculated EIRP_{APi} datasets are established for the defined, appropriate AP 3GPP channel and at the AP location and timestamp. The EIRP_{APi} datasets are delivered from each AP to the Sensitive Information Data Processing block within the PASS Incumbent Automated Analysis/Management Portal.

Incumbent System Information data is compiled and provided for each incumbent system of interest to the Sensitive Information Data Processing block within the PASS Incumbent Automated Analysis/Management Portal.

The EIRP “volume” for each AP is calculated based on Tx power, Tx antenna pattern, and excess path loss measurements. The Incumbent Portal calculates the Power Flux Density (PFD) at each incumbent system for each AP based upon the AP PFD in the direction of each incumbent system. Additionally, the PFD could include free space loss and/or address local clutter at an incumbent system in the calculation.

Within the Sensitive Information Data Processing block in the PASS Incumbent Automated Analysis/Management Portal the following is determined using the data inputs from process steps expressed above. Calculating the Power Flux Density (PFD_{(APi)Rx(i)}) for each AP (APᵢ) at each incumbent system (Rx(i)) at a specific timestamp is performed utilizing the following algorithm:

$${PFD}_{( A P i ) R x ( i )} = {( {P}_{t} + {G}_{t} - {L}_{R x ( i )} )}_{( A P i ) R x ( i )}$$

L_{Rx(i)} is the pathloss from APi to Rx(i). This calculated pathloss is the sum of up to three components:
a. Free space path loss (L_{FSP}) (in dB) calculated using a predefined pathloss tool appropriate for each link type (e.g., Ground-to-ground, ground-to-air, etc.)
b. The clutter loss the transmitter experienced in the direction of the i^{th} incumbent receiver which is measured by the PASS system at each AP, L_{ep(APi)Rx(i)} (in dB). (Step 1 above)
c. The local clutter loss at the receiver if known, L_{CLRx(i)} (in dB).

Since each value for the Gₜ is based on a vector between the AP and the target incumbent receiver at a specific timestamp and L_{(Rx)} is between the established locations of the same AP and incumbent receiver at the same specific timestamp, PFD_{(APi)Rx(i)} is the PFD vector and magnitude for that AP at that incumbent receiver.

The Incumbent System Rx sensitivity Threshold Volume may be calculated for each incumbent receiver requiring protection. This is performed within the Sensitive Information Data Processing block of the PASS Incumbent Automated Analysis/Management Portal.

Using the incumbent receiver data previously provided, the system determines the Incumbent System Rx Sensitivity Threshold Volume for each incumbent system that requires interference protection in the target 3GPP bands at its present location and timestamp utilizing operating Time and Location as previously described.

The Incumbent System i Sensitivity Threshold is calculated by I_Rx_{Th-i}=kTB+Fᵢ−G_{Rxi}−(I/N)_{Rx-i}

Where I_Rx_{Th-i} is the calculated Incumbent Systems Rx Sensitivity Threshold for the i^{th} incumbent receiver (in dBm). This is the value which the aggregated interference PFD calculated previously will be compared with determining if aggregate interference reduction is required. This calculation is repeated for all incumbent receivers requiring protection at their defined location and associated timestamps in the target 3GPP bands. In a non-limiting example, the calculation is performed for each Incumbent System.

The incumbent portal performs a calculation to aggregate AP PFD at each incumbent receiver requiring interference protection. To perform this calculation the incumbent portal aggregates PFDs from all APs. During the calculation if the aggregated APs PFD exceeds an established threshold at the incumbent system receiver, then the incumbent portal incrementally removes individual AP DL emissions consistent with established system priorities to reduce the aggregated interference at the incumbent system until the aggregate PFD for that incumbent receiver is equal to or less than the established threshold for that incumbent receiver.

The aggregate PFD for all APs is calculated as:

$${PFD}_{( AP \_ agg ) R x ( i )} = {\sum }_{i = 1}^{n} {PFD}_{( A P i ) R x ( i )} ( For Incumbent {Rx}_{i} ) .$$

In this non-limiting example, PFD_{(AP_agg)Rx(i)} is the aggregated interference PFD from all of the APs that can contribute to the aggregate interference at the i^{th} incumbent receiver requiring protection at the same specific timestamp.

The system may then compare super-positioned aggregated AP PFD to each incumbent Rx sensitivity threshold volume. Using the calculated aggregate PFD for all APs at each incumbent system as previously defined above and the calculated incumbent systems Rx sensitivity threshold volume, with each of these calculations performed for an established timestamp and incumbent receiver location, these calculations can be compared to determine if the aggregated APs PFD incident at the target incumbent receiver location (or volume) exceeds that incumbent system receiver's sensitivity threshold.

The comparison is performed as:

$$Is {PFD}_{( AP \_ agg ) R x ( N )} = {\sum }_{i = 0}^{n} {PFD}_{( A P i ) R x ( N )} < {I\_Rx}_{Th - N} ?$$

If this comparison returns a false result, then the APs contributing interference must lower their emissions such that the incumbent system receiver's sensitivity threshold is not exceeded. The PASS system then determines which of the APs are contributing interference and generates a list of those APs with PFD contributions, the amount by which the emissions from an AP in the list must be reduced, and in which direction from each AP the determined reduction must occur. Each of these parameters is generated for a current timestamp and location.

Excess pathloss measurements at each AP, AP directional EIRP data and meta data sets that indicate the excess path loss in every direction from an AP location are updated continuously based upon a predetermined update increment that utilizes time and incumbent receiver location as dependencies for the determination of update increment value. The calculation repetition rates for the incumbent system information, network AP EIRP volumes, incumbent system Rx sensitivity threshold volume, and the aggregate power flux density are based on the operational state and interference protection needs of the target incumbent receiver. Additionally, the availability of complete interference aggregation data sets are also used to allow for repeatable accurate calculations for all process steps described herein. These continuously updated data and meta data sets, and the calculations that are supported by the updated data and meta data sets operate to maintain a continuous, near real time acceptable determination of the calculated incumbent systems Rx sensitivity threshold volume and the calculated aggregate power flux density for all APs at each incumbent system.

The incumbent portal communicates which AP DL emissions are to be incrementally removed to each network supported by each AP.

The incumbent portal communicates AP emissions optimization recommendations to inform each wireless network operating in the target 3GPP band. The incumbent portal uses the calculation sequences herein described to inform each network operator as to which APs must reduce emissions to meet each impacted incumbent receiver's sensitivity threshold. Network operators receive this information from the incumbent portal at a predetermined periodicity, where the period timing is determined through a collaboration between the incumbent portal operations and the network operations staff. The information delivered includes a list of those APs which must be optimized, the power reduction increment required for each AP to be optimized, and the direction from each of these APs for which the emissions must be reduced.

The incumbent portal must also confirm the wireless networks AP operation optimization actions. After the network operators receive the AP optimization information from the incumbent portal the network operators must perform the necessary AP optimization actions. Subsequent to completing the necessary AP optimization actions, the network operators must provide confirmation information back to the incumbent portal to verify that the optimization actions have been performed to meet the emissions reductions as required.

Each of the measurement elements and algorithms described herein are equally important to achieving the solution of interference mitigation. The most significant assumption, outside the PASS system implementation described above, necessary for achieving the optimization solution as presented by the incumbent portal recommendations, is the availability of incumbent receiver information.

Turning now to FIG. 1, this figure presents a view of the operational flow for the PASS incumbent management portal information generation and presentation. As an initial matter, each of the measurement elements and algorithms presented in FIG. 1 and described herein are equally important to achieving the solution of interference mitigation. The most significant assumption, outside of the PASS system implementation presented, necessary for achieving the solution is the availability of incumbent receiver information upon which the calculations of interference occurrence and magnitude of interference mitigation are dependent. At a minimum, the following incumbent receiver information is assumed to be available and utilized in the PASS system sensitive information data processing: receiver sensitivity, receiver sensitivity threshold, receiver band and bandwidth, receiver antenna gain, receiver noise figure, operating time(s) and location (in GPS coordinates).

At 100 in a first step reference clear line of sight pathloss measurements are made at a reference measurement location and are presented as a set of vectors as reference information for each AP excess path loss measurement. At 102 the excess pathloss measurements are made at every AP. These path loss measurements include local “clutter” such as, in a non-limiting example, Building Exit Loss. The measured data set is a set of vectors which define a hemispherical excess pathloss environment/characteristic above that AP with each vector's magnitude defined by the excess pathloss measurement magnitude performed by the PASS measurement entity at that AP in that vector direction.

At 104 incumbent system information is communicated to the PASS incumbent automated analysis/management portal. The Incumbent System Information data includes, but is not limited to, the following information for each incumbent receiver that requires interference protection at defined timestamps in the target 3GPP bands.

### A. Incumbent Receiver Sensitivity—

An incumbent receiver's lowest receive level where the received signal can be processed (in dBm). This reference will be defined for PASS as the receiver Noise Floor (in dBm) which is equivalent to kTB+F where the receiver Noise Figure is F (in dB) where kTB is the thermal noise level (in dBm) across the incumbent receiver BW (B). Therefore, the incumbent receiver sensitivity is assumed to be at the Noise Floor where the Signal-to-Noise Ratio (SNR) is 0 dB.

### B. Incumbent Receiver Sensitivity Threshold ((IN)_{Rx-i})—

This threshold, in non-limiting examples, may be set at −10 dB, −14 dB, or any other threshold that may be required, is defined as being based upon the amount of maximum acceptable interference relative to the Noise Floor of that incumbent receiver (in dB).

### C. Receiver Frequency Band and Bandwidth—

The receiver frequency band and bandwidth define the incumbent receiver frequency range that must be protected. These terms may be defined based upon either the receiver center frequency (Fe) and BW (B) or based on the receiver low frequency (Fᵢ) and high frequency (Fₕ) limits which establish the BW.

### D. Incumbent Receiver Antenna Gain (G_{Rxi})—

Receive antenna gain in all azimuth and elevation directions for incumbent receiver Rₓ₋ᵢ (in dB) for a specific 3GPP band (in dB).

### E. Incumbent Receiver Noise Figure (Fᵢ)—

The established noise figure (F) for the i^{th} incumbent receiver (in dB).

### F. Operating Time—

This can be defined as either scheduled operation time(s) or a real time “On” or “Off” state designation.

### G. Location (GPS Coordinates)—

The incumbent receiver can be fixed or in motion so this can be represented by a fixed or a changing coordinate set with associated timestamps. This can be a three-dimensional coordinate set relative to the surface of the earth.

At 106 all APs provide data supporting their EIRP “volume” determination information to the incumbent portal within a defined time period, where the time period may be set as required. The PASS Incumbent Automated Analysis/Management Portal receives as inputs the AP PASS data and separately, operation optimization confirmation messages, and provides as an output the channel optimization notifications to be communicated to PASS system users.

At 108 the PASS Incumbent Automated Analysis/Management Portal performs sensitive information data processing calculations. The incumbent system information data is compiled and provided for the devices within each incumbent system of interest to the sensitive information data processing block. During the calculations, the EIRP “volume” for each AP may be calculated based upon Tx power, Tx antenna pattern, and excess path loss measurements. The incumbent portal may calculate PFD at each incumbent system for each AP based upon the AP PFD in the direction of the incumbent system. This calculation may include free space loss and/or address local clutter at incumbent system in the calculation.

In another calculation the incumbent portal may calculate the incumbent system Rx sensitivity threshold volume for each incumbent receiver requiring protection from excess interference conditions.

In yet another operation the incumbent portal may calculate the aggregated AP PFD at each incumbent system. This calculation may include aggregating PFDs from all APs to determine the total aggregated PFD value. If this aggregated PFD value exceeds a previously established threshold for the aggregation value at the incumbent system receiver, the incumbent system process may incrementally remove certain PFD AP DL emissions from the calculated aggregated PFD value at the incumbent system until the aggregated PFD value is at or below the established threshold value. This final aggregation calculation and comparison optimizes the aggregated PFD value for all APs for a certain pre-established time period.

At 110 the incumbent portal receives the optimized value from the incumbent system sensitive information data processing module and communicates the identity of the AP DL emission that should be incrementally removed to meet the established threshold value for the aggregated PFD value. The PASS incumbent dashboard may then inform wireless networks of the AP emissions optimization recommendation and confirms the MNO and PAL networks AP operation optimization actions. These operations are performed for both new entrant PFD volumes and incumbent PFD volumes.

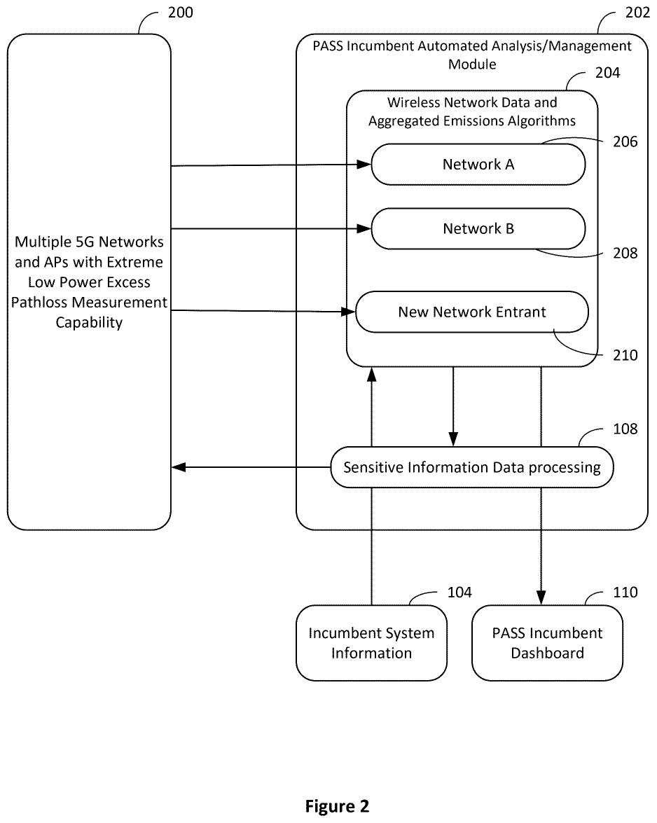

Turning now to FIG. 2, this figure presents a structural representation of the PASS incumbent analysis portal for Network Integration. At 300 multiple 5G networks and APs that have the capability to measure extreme low power excess pathloss measurements transmit these excess pathloss measurements to the PASS incumbent analysis portal at 302. The PNT Assisted Spectrum Sharing (PASS) algorithms are active on defined servers (306, 308) and receive Network AP parameters including the 3GPP channel, time, location, 3-D directional AP path loss, and AP directional EIRP as data values that are input to PASS algorithms for use in the calculation of individual AP PFD for all APs in the network. The outputs from Block 304 are provided to Block 106, the sensitive information data processing module, for the execution of the PASS optimizations and recommendations. The PASS algorithm calculations performed in Block 106 include the incumbent receiver sensitivity thresholds, the aggregate AP PFD from all APs which are incident on each of the incumbents to be protected, and comparisons between these to determine if the incumbent receiver sensitivity thresholds have been exceeded and, if necessary, what network AP optimizations are to be executed to lower the aggregate AP PFD below that threshold.

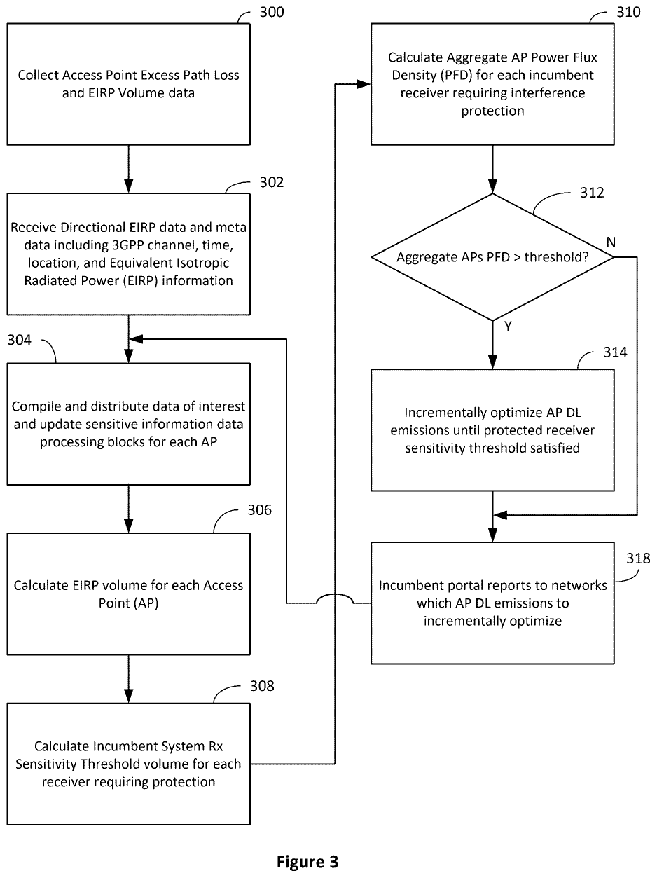

Turning now to FIG. 3, this figure presents a view of the operational flow for the continuous calculation of AP Downlink emissions to be incrementally removed to optimize AP protection. This figure presents the process in broad terms, for which the terms are defined and specified above.

At 300 the real-time data measurements for the AP excess path loss and EIRP volume are collected at each AP and transferred to the PASS incumbent automated analysis/management application as a portal data server. At 302 the PASS data server receives real-time data measurements and metadata information for directional EIRP data and metadata from all APs including, but not limited to, the 3GPP channel, time, location and Equivalent Isotropic Radiated Power (EIRP) information. At 304 the PASS incumbent automated analysis/management portal data server distributes data of interest to the sensitive information data processing module for the calculation of individual AP PFD volumes in the sensitive information data processing block. At 306 the incumbent automated analysis/management application calculates the EIRP volume for each AP. At 308 the PASS incumbent automated analysis/management application calculates the incumbent system Rx sensitivity threshold volume for each incumbent receiver device requiring interference protection. At 310 the incumbent automated analysis/management application calculates the aggregate AP power flux density (PFD) for each incumbent receiver device requiring interference protection and stores the aggregated PFD in said data block. At 312 the PASS incumbent automated analysis/management application compares the calculated aggregated APs PFD against a pre-set aggregate AP PFD threshold for a particular time interval. If the calculated aggregate AP PFD volume value is greater than the pre-set aggregate AP PFD threshold for that particular time interval the PASS incumbent automated analysis/management application removes AP emissions having the greatest contributing PFD volume(s) and recalculates the aggregate AP PFD volume until the aggregate AP PFD volume value is less than or equal to the pre-set aggregate AP PFD threshold for that particular time interval. The PASS incumbent automated analysis/management application storing the identity of the AP for each set of AP emissions removed from the calculated aggregated APs PFD

At 316 the incumbent system checks to determine if the time interval value has been met. If the time interval value has not been met, the process returns to step 304 to continue the calculations for the time interval to optimize the aggregate AP PFD value for that particular time interval. If the time interval has been met the PASS incumbent automated analysis/management application at 318 reports to the wireless networks which AP DL emissions to incrementally remove as recommendations and operational instructions to achieve the optimized aggregated AP PFD value from all APs.

We claim:

1. A system for optimizing wireless network dynamic spectrum sharing, comprising:
one or more data servers connected to a wireless network;
a PNT Assisted Spectrum Sharing (PASS) System active within one or more of said connected data servers;
said PASS System in network communication with a plurality of wireless network Access Points (APs);
each of said APs providing Equivalent Isotropic Radiated Power (EIRP) data and metadata as real-time data measurements and characteristic information to the PASS System;
said PASS System receiving each AP's EIRP real-time measurement data, characteristic information, and metadata measuring excess path loss;
said PASS System providing excess path loss for each AP to the PASS Incumbent Automated Analysis/Management module;
the PASS Incumbent Automated Analysis/Management module calculating the EIRP volume for each AP;
the PASS Incumbent Automated Analysis/Management module calculating incumbent system receiver sensitivity threshold volume for each incumbent receiver device requiring interference protection in real time;
the PASS Incumbent Automated Analysis/Management module calculating the aggregate AP power flux density (PFD) for each incumbent receiver device requiring interference protection;
the PASS Incumbent Automated Analysis/Management module comparing the calculated aggregated APs PFD against a pre-set aggregated AP PFD threshold;
the PASS incumbent automated analysis/management application optimizing AP emissions from said calculated aggregated APs PFD to reduce the calculated aggregated APs PFD to a value below said pre-set aggregated AP PFD;
storing the identity of the AP for each set of AP emissions removed from the calculated aggregated APs PFD;
the PASS incumbent automated analysis/management application reports to the wireless networks which AP DL emissions to incrementally ren-eve optimize as recommendations and operational instructions to achieve the optimized aggregated AP PFD value from all APs to provide optimized interference protection for each receiver device requiring interference protection.

2. The system of claim 1, where said PASS Incumbent Automated Analysis/Management module distributing data of interest to a sensitive information data processing module (SIDP).

3. The system of claim 1, where said SIDP stores all data of interest within one or more data blocks within electronic storage devices in said one or more network connected data servers.

4. The system of claim 1, where PASS Incumbent Automated Analysis/Management module identifies each AP PFD emission volume.

5. The system of claim 4, where PASS Incumbent Automated Analysis/Management module identifies which AP PFD emission volumes provide the largest emission volume in an aggregation calculation.

6. The system of claim 1, where the PASS Incumbent Automated Analysis/Management module repeats the data collection, calculations, data aggregation, and comparison actions such that the protection thresholds for the incumbent receivers requiring protection are not exceeded.

7. The system of claim 1, where the characteristic information from all APs includes at least the 3GPP channel, time, location and EIRP information.

8. The system of claim 1, where the metadata measurements at each AP define the excess path loss hemispherical “volume”, and provides a description of the excess path loss in every direction from the location of the AP.

9. A method for optimizing wireless network dynamic spectrum sharing, comprising:
a PNT Assisted Spectrum Sharing (PASS) System in network communication with a plurality of wireless network Access Points (APs);
each of said APs providing Equivalent Isotropic Radiated Power (EIRP) data and metadata as real-time data measurements and characteristic information to the PASS System;
said PASS System receiving each AP's EIRP real-time measurement data, characteristic information, and metadata measuring excess path loss;
the PASS System calculating the EIRP volume for each AP;
the PASS System calculating incumbent system receiver sensitivity threshold volume for each incumbent receiver device requiring interference protection in real time;
the PASS System calculating the aggregate AP power flux density (PFD) for each incumbent receiver device requiring interference protection:
the PASS System comparing the calculated aggregated APs PFD against a pre-set aggregated AP PFD threshold;
the PASS System optimizing AP emissions from said calculated aggregated APs PFD to reduce the calculated aggregated APs PFD to a value below said pre-set aggregated AP PFD;
storing the identity of the AP for each set of AP emissions removed from the calculated aggregated APs PFD;
the PASS System reporting to the wireless networks which AP DL emissions to incrementally optimize as recommendations and operational instructions to achieve the optimized aggregated AP PFD value from all APs to provide optimized interference protection for each receiver device requiring interference protection.

10. The method of claim 9, where said PASS System distributes data of interest to a sensitive information data processing module (SIDP).

11. The method of claim 9, where said SIDP stores all data of interest within one or more data blocks within electronic storage devices in said one or more network connected data servers.

12. The method of claim 9, where PASS System identifies each AP PFD emission volume.

13. The method of claim 12, where PASS System identifies which AP PFD emission volumes provide the largest emission volume in an aggregation calculation.

14. The method of claim 9, where the PASS System repeats the data collection, calculations, data aggregation, and comparison actions such that the protection thresholds for the incumbent receivers requiring protection are not exceeded.

15. The method of claim 9, where the characteristic information from all APs includes at least the 3GPP channel, time, location and EIRP information.

16. The method of claim 9, where the metadata measurements at each AP define the excess path loss hemispherical “volume”, and provides a description of the excess path loss in every direction from the location of the AP.
